(19) United States
(12) Patent Application Publication
(10) Pub. No.: US 2002/0134902 A1
(43) Pub. Date: Sep. 26, 2002

(54) Shifting plate

(76) Inventor: Yu Wen Cheng, Taichung City (TW)

Correspondence Address: Keith Kline, PRO-TECHTOR INTERNATIONAL SERVICES, 20775 Norada Court, Saratoga, CA, 95070-3018, US

(21) Appl. No.: 09/858,002

(22) Filed: May 14, 2001

(30) Foreign Application Priority Data
Mar. 22, 2001 (TW) 90204370

(51) Int. Cl. A47G 29/00; A61G 7/08; B65D 19/00

(52) U.S. Cl. 248/346.01; 5/81.1 HS

(57) ABSTRACT

A shifting plate, comprising: a front guiding support, a rear guiding support, left and right terminating bars, a seat plate, and several rolls on front and rear edges of the seat plate. The front and rear guiding supports have guiding grooves on inner sides that face each other. The left and right terminating bars are attached to left and right ends of the front and rear guiding supports. The seat plate is placed between the front and rear guiding supports. The rolls stay inside the guiding grooves of the front and rear guiding supports without being fixed, allowing to move the seat plate in left and right directions.

### BACKGROUND OF THE INVENTION

1. Field of the Invention

The present invention relates to a shifting plate, particularly to a shifting plate for persons who are paralyzed or handicapped or who cannot use their feet with force.

2. Description of Related Art

Today's society is increasingly getting older with more and more people unable to move normally. For persons who are handicapped or who cannot use their feet with force, the small movement of shifting between a bed and a wheelchair or between a chair and a wheelchair constitutes a great problem. Lying in bed for extended periods of time without moving badly affects health of a patient, and dependence on the assistance of others is inconvenient. Since nurses are hard to find and expensive, small movements of shifting places are done by the patient herself or himself. For this, assisting tools have been developed.

As shown in FIG. 3, a conventional shifting plate 80 is an elongated plate, having a length which is roughly equal to the length of the arms of the patient plus the width of her or his body, normally about 25-30 inch. During use, the patient puts one end of the shifting plate 80 on the bed, and the other end on a chair or wheelchair, places the backside on the shifting plate 80 and slowly glides thereon, assisted by the hands or the feet, to reach the chair from the bed. Of course, the reverse movement from the chair to the bed or another movement is done in the same way.

Using this kind of shifting plate is cumbersome and slow, yet provides a lot of convenience for the patient, enabling the patient to perform small shifting movements on her or his own for a wide range of applications.

However, this kind of shifting plate has the following shortcomings: 1. A large weight due to wooden or plastics material makes it difficult to take up and position the plate. 2. A lack of other helping designs allows the patient only to move slowly.

### SUMMARY OF THE INVENTION

It is an object of the present invention to provide a shifting plate that is easily carried and taken along.

Another object of the present invention is to provide a shifting plate that facilitates shifting of a patient by having rolls.

The present invention can be more fully understood by reference to the following description and accompanying drawings.

### BRIEF DESCRIPTION OF THE DRAWINGS

FIG. 1 is an exploded view of the shifting plate of the present invention.

FIG. 2 is a perspective view of the shifting plate of the present invention.

FIG. 3 (prior art) is a perspective view of a conventional shifting plate.

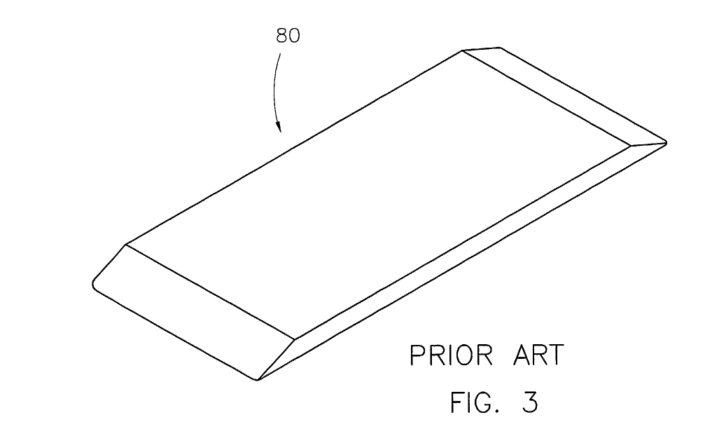

### DETAILED DESCRIPTION OF THE PREFERRED EMBODIMENT

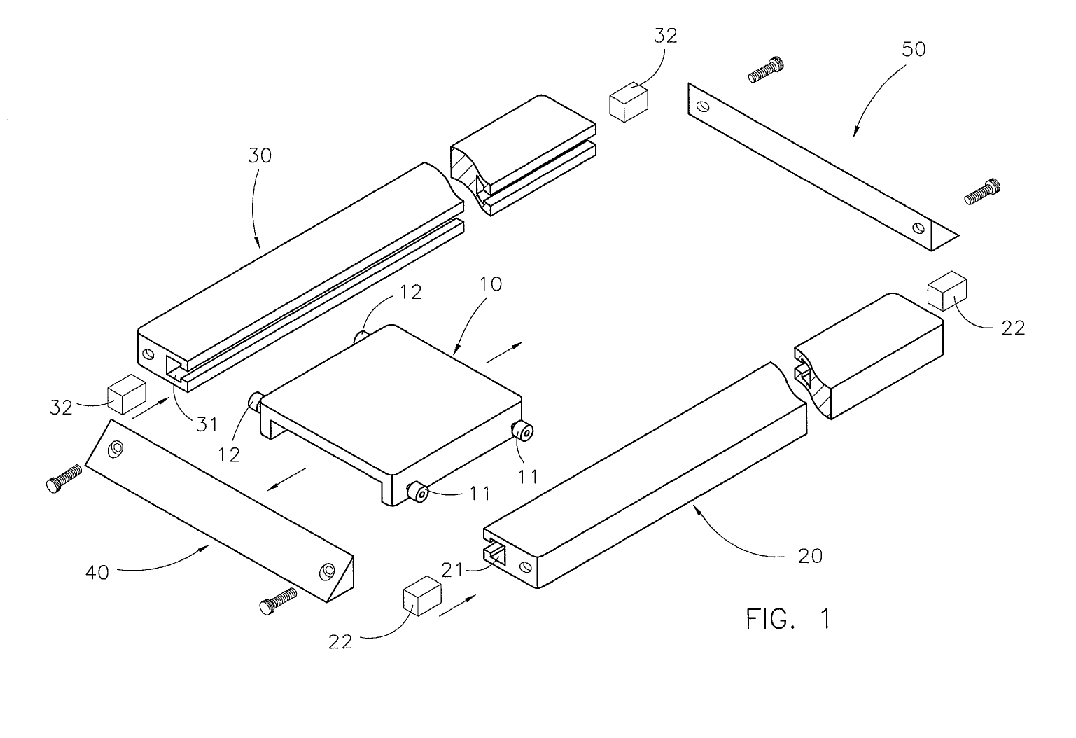

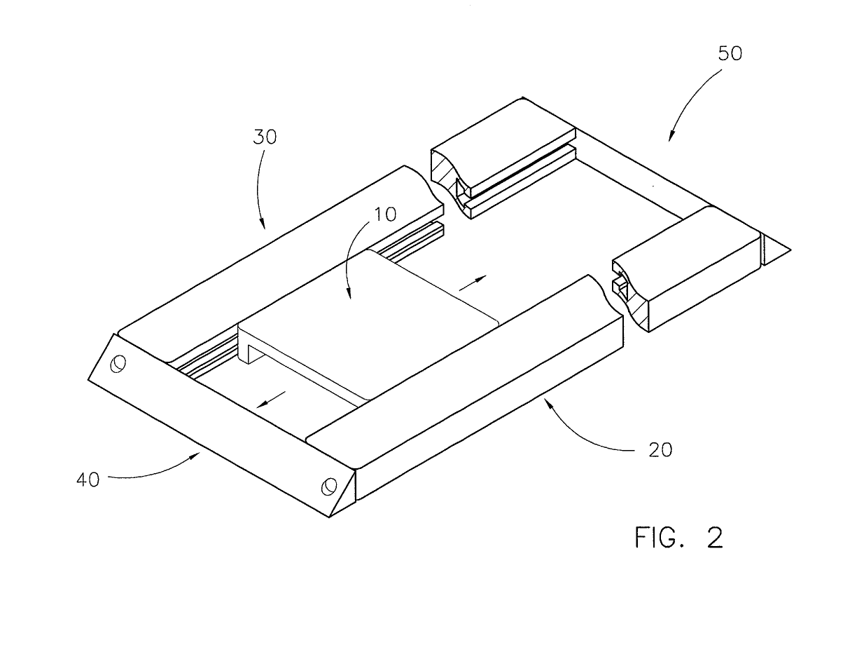

As shown in FIGS. 1 and 2, the shifting plate of the present invention in a first embodiment mainly comprises: a seat plate 10; a front guiding support 20; a rear guiding support 30; a left terminating bar 40; and a right terminating bar 50. The front and rear guiding supports 20, 30 and the left and right terminating bars 40, 50 form a rectangular frame. The seat plate 10 is placed between the front and rear guiding supports 20, 30, gliding there to the left or to the right, as explained in detail below:

The front and rear guiding supports 20, 30 are elongated bodies, located opposite to each other and having inner sides with guiding grooves 21, 31 as well as having left and right ends, which are connected by the left and right terminating bars 40, 50, respectively, to form a rectangular frame. The left and right terminating bars 40, 50 have inclined outer surfaces, allowing the patient easily to enter and leave the shifting plate.

The seat plate 10 is shaped like a square, having a front edge and a rear edge which are respectively provided with several rolls 11, 12. The rolls 11, 12 stay inside said guiding grooves of said front and rear guiding supports without being fixed, allowing left and right movements of the seat plate 10 along the front and rear guiding supports 20, 30. For the convenience of the patient, a seat cushion (not shown) may be placed on the seat plate 10. As shown in FIG. 1, distance blocks 22, 32 are placed at the left and right ends of the guiding grooves 21, 31 to stop the seat plate 10 at a distance from the left and right terminating bars 40, 50, avoiding squeezing of the fingers of the patient.

In order to reduce noise and moving speed of the seat plate 10, the rolls 11, 12 are preferably made of soft material. To reduce weight, the main structural parts of the shifting plate are preferably made of aluminum.

The left and right terminating bars 40, 50 and the ends of the front and rear guiding supports 20, 30 are plated with material of high friction (not shown), so as not to slip away from a support.

When using the shifting plate of the present invention, the patient first pulls the seat plate 10 to the near end of the shifting plate, places the near end below the backside and the far end at a destination of the shifting movement, sits on the seat plate 10 while holding the front and rear guiding supports 20, 30 or the terminating bar on the far end, and slowly moves towards the destination.

The shifting plate of the present invention substitutes a rolling movement for the gliding movement of prior art. Therefore, the patient uses the force of the arms effectively and does not need the arms for supporting the body.

The present invention provides a solution for the following problems:

1. A rolling movement is performed with less friction than a gliding movement, using of rolls by the present invention saves effort by the patient.

2. The patient only needs to sit on the seat plate and is not required to support the body again and again by the arms.

3. The patient may hold the terminating bar on the opposite end and comfortably pull herself or himself along.

4. Shifting is done in less time, with an obvious advantage when shifting along an inclined path.

While the invention has been described with reference to a preferred embodiment thereof, it is to be understood that modifications or variations may be easily made without departing from the spirit of this invention which is defined by the appended claims.

1. A shifting plate, comprising:
a front guiding support, having a guiding groove at a rear side;
a rear guiding support, having a guiding groove at a front side;
left and right terminating bars, attached to left and right ends of said front and rear guiding supports;
a seat plate, placed between said front and rear guiding supports; and
several rolls, disposed on front and rear edges of said seat plate;
wherein said several rolls stay inside said guiding grooves of said front and rear guiding supports without being fixed, allowing to move said seat plate in left and right directions.
